(19) United States
(12) Patent Application Publication
(10) Pub. No.: US 2025/0392030 A1
(43) Pub. Date: Dec. 25, 2025

(54) INFLATABLE ANTENNA STRUCTURES AND METHODS OF MANUFACTURE

(71) Applicant: Remarkable Technologies, Inc., Avon, CT (US)

(72) Inventor: Eric A. Knight, Unionville, CT (US)

(21) Appl. No.: 19/243,187

(22) Filed: Jun. 19, 2025

Related U.S. Application Data
(60) Provisional application No. 63/731,909, filed on Jun. 20, 2024.

(51) Int. Cl. H01Q 1/08; H01Q 9/30

(52) U.S. Cl. CPC H01Q 1/081; H01Q 9/30

(57) ABSTRACT

An inflatable antenna structure composed of flexible, electrically conductive material is disclosed. When inflated, for example, with air or lighter-than-air gas, the structure assumes antenna geometries suitable for a wide range of RF transmission and reception requirements. Also, when inflated, the structure can be lofted and deployed hundreds or more feet into the sky, enabling extended communication capabilities. The structure includes at least one inflation-deflation port and at least one electrical-connectivity port. One or more embodiments include offering significant advantages over conventional antenna structures with respect to weight, size, portability, performance, and manufacturability.

### CROSS-REFERENCE TO RELATED APPLICATIONS

This application claims the benefit of priority under 35 U.S.C. § 119 (e) to U.S. Provisional Patent Application No. 63/731,909, titled Inflatable Antenna Structures and Methods of Manufacture, filed on Jun. 20, 2024, the entire disclosure of which is hereby incorporated by reference.

### FIELD

The present invention relates to antenna systems and radio frequency (RF) transmission and reception, and more specifically to inflatable antenna structures composed of flexible, electrically conductive materials that form a pressure-retaining geometry capable of operating as a radiating or receiving element for RF communication.

### BACKGROUND

Antennas are devices that facilitate radio wave transmission and reception. Countless antenna designs have been created and used since the German physicist Heinrich Hertz discovered radio waves in the 1880 s.

A sample of antenna names, types, and designs include the following: wire antennas, doublet ante. as, dipole antennas, half-wave dipole antennas, short-dipole antennas, broadband dipole antennas, off-center-fed (OCF) dipole antennas, monopole antennas, vertical antennas, vertical monopole antennas, vertical dipole antennas, folded-dipole antennas, fan-dipole antennas, loop and delta-loop antennas, cloverleaf antennas, travelling-wave antennas, helical antennas, Yagi-Uda antennas (also known as Yagi antennas), array antennas, two-element array antennas, multi-element array antennas, linear-array antennas, phased-array antennas, spiral antennas, reflector antennas, corner-reflector antennas, flat-plate reflector antennas, parabolic reflector antennas (also known as dish antennas), microstrip antennas, rectangular microstrip antennas (also known as patch antennas), quarter-wave patch antennas, inverted-f antennas, planar inverted-f antennas (PIFA), bow-tie antennas, log-periodic antennas, log-periodic dipole array antennas, aperture antennas, slot antennas, horn antennas, cavity-backed slot antennas, inverted-v antennas, slotted waveguide antennas, NFC antennas, fractal antennas, wearable antennas, and lens antennas. It should be noted that this is not an all-inclusive list.

### SUMMARY

Alternating current (AC), and further in the case of this invention disclosure, radio-frequency waves (RF), flow primarily on the surface or “skin” of an electrical conductor. As used herein, skin effect refers to the general tendency of high-frequency electric currents to flow mostly along the outer surface of a conductor, instead of through the entire conductor. This happens to a continually greater extent as the frequency increases.

A formula for calculating skin depth is as follows:

δ=√[2ρ/(2πf)(μ₀μᵣ)]
Wherein:
   δ is skin depth in meters
   ρ is resistivity of the conductor in ohm-meters (Ω·m): (1.678×10⁻⁸ for copper at room temperature)
   f is frequency in hertz
   μ₀ is permeability of free space: 4π×10⁻⁷
   μᵣ is relative permeability of the conductor (0.99991 for copper)

Applying the above formula, and purely for examples, the skin depth in copper at 5 MHz is 0.00115 inches (roughly a thousandth of an inch) and at 100 MHz is 0.00026 inches (roughly a quarter of a thousandth of an inch). These examples demonstrate how skin depth shrinks rapidly as frequency increases.

With the knowledge that RF current flows predominantly on a conductor's surface—the “skin” of the conductor—an RF-transmission medium can be created that does not require substantial thickness.

Accordingly, one or more embodiments include leveraging the skin effect, primarily comprised of electrically conductive polymetric materials and metallized plastic films that are sealed and inflated to form pressure-holding tubular structures.

When inflated, the structures form a physically stable, highly efficient RF-receiving-and-radiating element with geometry suitable for a wide range of RF applications. The inflatable structures include at least one electrical connectivity port and an inflation port and/or valve. The innovative antenna structures can be fabricated simply, efficiently, and at low cost.

Inflatable antenna structures enabled by one or more embodiments can be substituted for traditional antenna designs and structures—such as those itemized in the BACKGROUND section—as well as provide opportunities for new antenna structures to be discovered and enabled by the novel characteristics of this innovation.

Manufacturing methods are also provided herein.

### BRIEF DESCRIPTION OF THE DRAWINGS

FIG. 1 is a line drawing showing a heat-sealing apparatus for creating an airtight structure along with a section of metalized film, in accordance with at least one embodiment.

FIG. 2 is a photograph of the metalized film used in at least one embodiment.

FIG. 3 is a photograph of a compact tabletop impulse heat sealer in accordance with at least one embodiment.

FIG. 4 is a line drawing of a Boston valve used for inflation and deflation of one embodiment of an inflatable antenna structure.

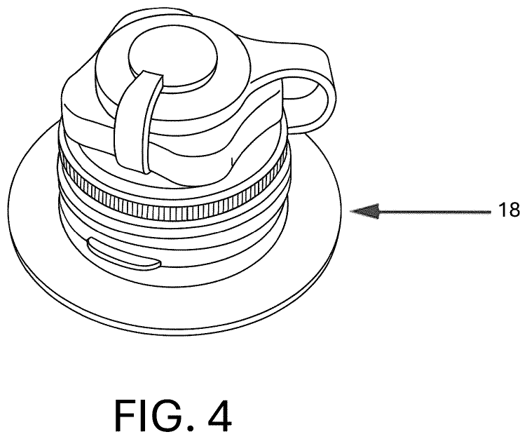

FIG. 5 is a photograph of an electrical-connection port (e.g., a banana jack) embedded in the sealed end of an inflatable antenna structure in accordance with at least one embodiment.

FIG. 6 is a photograph showing inflation and positioning of an example embodiment of an inflatable antenna structure.

FIG. 7 is a photograph of a standing wave radio (SWR) reading on a MINI60S (SARK-100 derivative) antenna analyzer in accordance with at least one embodiment.

FIG. 8 is a photograph of the data displayed, including SWR, on a NanoVNA vector network analyzer in accordance with at least one embodiment.

FIG. 9 is a photograph showing an example embodiment of an inflatable antenna structure laid horizontally on the ground during construction.

FIG. 10 is a photograph of an example embodiment of an antenna structure deployed vertically in an outdoor setting.

FIG. 11 is a photograph of an example embodiment of an inflatable antenna structure deployed vertically in another outdoor setting.

FIG. 12 is a photograph of a successful on-air field test of an example embodiment of an inflatable antenna structure, with deployed ground radials visible and noted.

FIG. 13 is a line drawing of an example embodiment of an inflatable antenna structure, including the pressure-retaining enclosure, electrical (e.g., RF) port, inflation port, ground radials, feedline, and antenna analyzer.

FIG. 14 is a line drawing of a dipole antenna formed in accordance with one or more embodiments of an inflatable antenna structure connected to a coaxial cable.

FIG. 15 is a line drawing of a delta loop antenna of an inflatable antenna structure, in accordance with one or more embodiments.

FIG. 16 is a line drawing depicting a connected pair of elements of an inflatable antenna structure used as a parasitic radiator in a directional array antenna in accordance with at least one embodiment.

FIG. 17 is a line drawing showing an example embodiment of a lighter-than-air inflated antenna structure with feedline tethering, inflation port, electrical (e.g., RF) port, overpressure valve, and compact transceiver.

FIG. 18 is a flow diagram of a method for manufacturing an inflatable radio-frequency antenna structure.

Black and white photographs have been included in the drawing set, as the nuances and surface textures of the innovation and the data represented in the digital/analog displays of the testing equipment are more clearly represented than with line drawings.

### DETAILED DESCRIPTION

Antenna portability and deployability are especially critical in certain contexts such as, for example, amateur radio, military, disaster recovery, and emergency communications. Traditional antennas are typically constructed of rigid metallic materials—commonly tubes and pipes made of aluminum, copper, or steel—providing the fixed geometries necessary to ensure effective performance. These antenna structures are often bulky, difficult to store, fragile during transport, and are challenging for emergency or field deployment. Because of extensive use of solid-metal components, these antenna structures are typically expensive to produce and have correspondingly significant supply-chain and end-user price tags.

Wire-based antennas provide an alternative design approach. They offer portability but inherently lack a self-supporting structure and/or require additional rigging to maintain the necessary communication geometry. Wire-based antennas can also exhibit narrower bandwidth and other communication deficiencies as compared to larger metallic antenna structures.

Despite the growing need for portable, rapidly deployable, lightweight, high efficiency, high performance, and cost-effective antennas, conventional antenna structures typically fail to meet these criteria.

One or more embodiments include providing significant weight reduction, enhanced performance, greater portability, and a dramatic simplification of deployment logistics—among many other virtues. As will be shown and described, a fully functional, high-performance antenna structure can be comfortably and discreetly stowed in an ordinary pants pocket, weigh as little as an ounce or two, and be deployed in a handful of seconds.

There is a wide range of metalized, conductive films and electrically conductive polymetric materials and substrates suitable for use in one or more embodiments. A sample includes:
Chrome-metallized polyester/polyethylene terephthalate (PET)/plastic film
Aluminum metalized film/aluminized plastic film/aluminized PET film/aluminized polyester film
Gold-metallized polyester/PET/plastic film
Brushed stainless steel polyester/PET/plastic film
Metal pewter polyester/PET/plastic film
Matte-aluminum-metallized polyester/PET/plastic film
Metalized biaxially oriented polyethylene terephthalate (BoPET), a metalized polyester film made from stretched PET.

For the purposes of this invention disclosure, all the above types and variants of metalized film and metalized/conductive polymer substrates, as well as others that have not been explicitly referenced but available and understood by industry, manufacturing, and/or those skilled in the art, are generally referenced herein as metalized film.

Metalized film is formed into substantially “airtight” compartments of various shapes, sizes, and dimensions as chosen by the user for the selected application. “Airtight,” as used herein, is a general expression and does not mean that the compartment(s) associated with the disclosed invention embodiments must be filled with air. On the contrary, the compartment(s) may be filled with any gas or gas mixture that the user selects and is appropriate for an intended application.

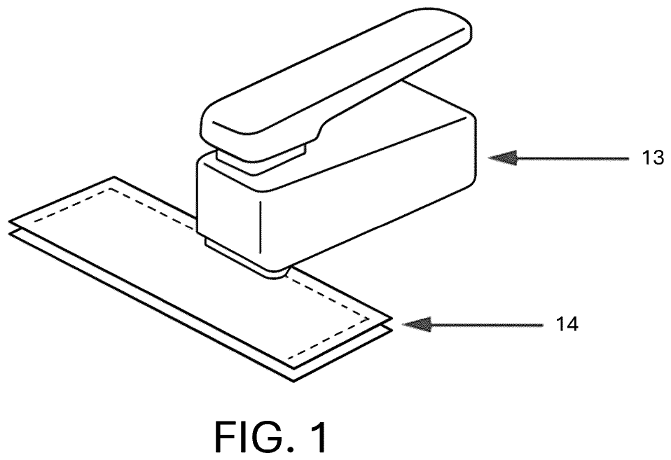

Shown is a method for creating an airtight compartment using a metalized film 14 (such as depicted in FIG. 1) and an impulse heat-sealer 13 (such as also depicted in FIG. 1).

Also, “airtight” does not mean that the created compartment or compartments of the disclosed embodiments must be permanently sealed. On the contrary, a user may prefer that the “airtight” compartment(s) be filled and unfilled with a gas or gas mixture. Inflation-deflation ports, valves, plugs, caps, or functional equivalents for filling, unfilling, and maintaining the applied gas, or to increase or decrease the gas volume and/or gas pressure, may be incorporated. Many types of inflation-deflation ports, valves, plugs, and caps may be considered and selected, including but not limited to those constructed of plastic, elastomer, polymer, composite, metal, metal-plastic hybrid, or other suitable materials.

Various gas pressures may be chosen or preferred.

Overpressure valve or valves or functional equivalents may also be included.

As detailed herein, one or more embodiments are constructed, sized, and configured to operate on desired radio frequencies. A surprising, unexpected, novel, and beneficial characteristic of such an embodiment includes the discovery that structures composed of inflated metalized-film appear to show frequency resonance in smaller sizes than traditionally calculated for traditional solid-metal and wire antenna constructions.

For example, the length, in feet (L), of a traditional half-wave dipole antenna, for a particular frequency (f) is: L (ft)=468/f (MHz). Correspondingly, the length of a traditional quarter-wave vertical antenna is calculated as: L (ft)=234/f (MHz). However, construction, analysis, and testing of various embodiments indicate that this standard formula may need to be adjusted to properly calculate the size the inflated elements—as an unexpected result, with significant benefits, occurred.

Specifically, quarter-wave vertical antennas constructed with the innovation's metalized-film tubular structure have shown to be approximately 4% to 9% shorter than traditional antennas constructed of solid metal or wire. The length savings—in and of itself—provide significant end-user benefits, including smaller deployment heights and lengths and wider opportunities for antennas to be placed in space-limited areas. This unexpected result—that the standard construction formula does not predict or anticipate—leads to new possible uses and application possibilities.

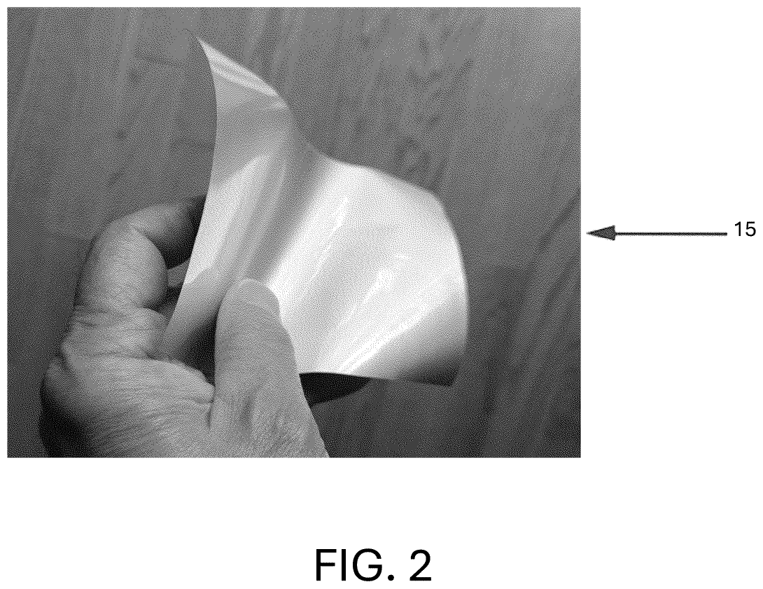

In at least one example embodiment, the metalized film used is a four-layer, aluminum-metallized film with an outer layer of PET, a 0.00035-inches-thick aluminum foil layer, an adhesive layer to bond the PET layer to the aluminum foil, and an inner layer of metallocene linear low-density polyethylene (LLDPE) for heat sealing. A photograph of this thin, flexible, metalized film can be seen in photograph 15 in FIG. 2.

As used herein, the term “flexible” generally refers to the ability to bend or adapt without breaking.

The four-layer, aluminum-metallized film used in this example embodiment exhibits high electrical conductivity and heat-sealing capability, allowing it to serve as both a structural and a functional RF-radiator material.

The total thickness of the film is approximately 5.0 mils.

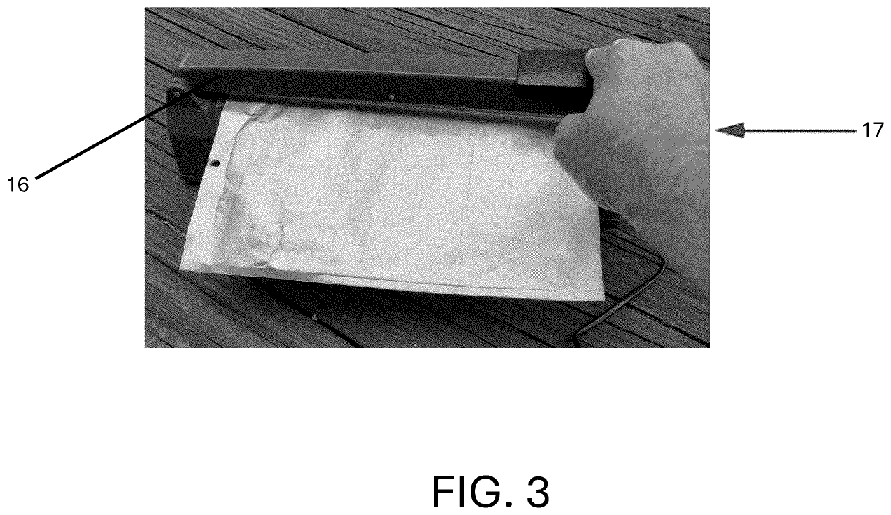

Construction of this embodiment's tubular antenna structure can include cutting and heat-sealing lengths of the metallized film using a consumer-grade impulse heat sealer, as depicted via element 16 in FIG. 3. Additionally, element 17 in FIG. 3 shows a test of the heat-sealing process. Using the metallized film and the heat-sealing process, an air-tight/gas-tight antenna structure—approximately 15.54 feet long and four inches in diameter—was created; the completed structure is further described herein.

In accordance with one or more embodiments, the sealing of the metallized film or other chosen metalized flexible material to form an electrically conductive pressure-retaining enclosure (of any needed shape or configuration) may be accomplished using a variety of methods, including but not limited to heat sealing, taping, ultrasonic welding, and adhesive bonding. Heat sealing may be performed with impulse heat sealers, continuous band sealers, or similar devices capable of bonding thermoplastic layers without degrading the conductive surface.

In terms of antenna production, complete manufacturing (including all metalized-film/metalized flexible material sealing operations) can be accomplished using high-speed manufacturing, mechanized or manual assembly-line operations, and/or robotic processes. Alternatively, for simplified manufacturing and ease of field-based construction and deployment, the sealing method can be done using consumer-grade and/or portable tools. Such tools can include, for example, table-top impulse sealers such as depicted by element 16 in FIG. 3, handheld and battery-operated heat sealers, adhesive applicators, tape dispensers, or compact ultrasonic-welding devices. Such tools allow the inflatable antenna structure to be fabricated or repaired in environments where industrial manufacturing equipment may be unavailable—such as in remote locations, during emergency operations, or by radio operators in the field.

The use of resealable techniques, such as pressure-sensitive adhesives or hook-and-loop closures, may also be incorporated in specific variants to permit disassembly or reconfiguration without compromising gas retention.

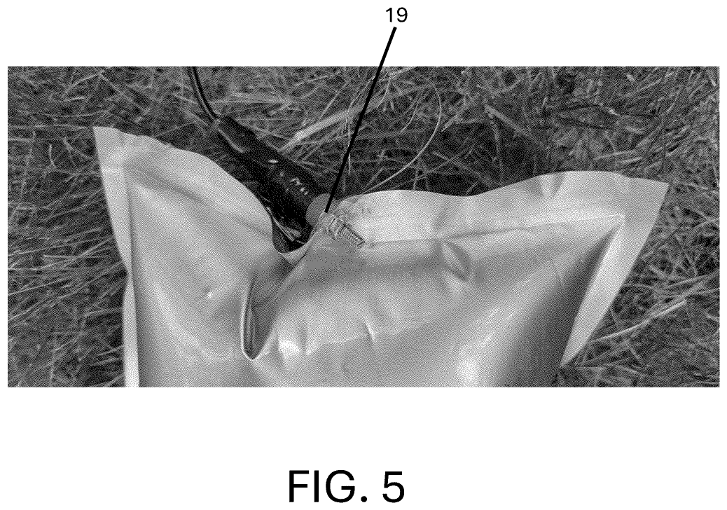

As depicted in FIG. 5, a Boston valve 18 can be installed to create a port to facilitate inflation and deflation.

An RF-capable connector can be used to create an electrical-connection port for the RF feed. In at least one embodiment, the electrical-connection port can be created by a banana jack inserted into the heat-sealed end of the antenna structure, such as illustrated via element 19 in FIG. 5. It is important to note that the RF-capable connector used for the electrical-connection port may be adapted to accommodate a variety of feedlines, including but not limited to coaxial cable, twin-lead, ladder line, or single-wire conductors. In some embodiments, clamping, soldering, adhesive, or other mechanical or bonding methods may be used to establish the electrical interface between the antenna and the chosen feedline type.

The antenna's tubular structure can be inflated, for example, with ambient air. Note that other gases, especially lighter-than-air gases, such as helium, could be used—and, in some applications, preferred.

In at least one embodiment, a coaxial cable feedline is connected to the feed point. The center conductor of the coaxial cable can be attached to a banana plug that is inserted into the antenna's banana jack. The outer conductor (braid) of the coaxial cable can be connected to the electrical intersection of ground radials.

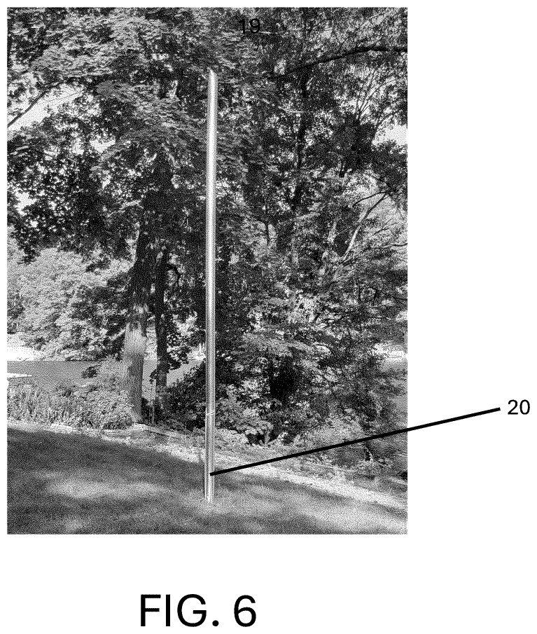

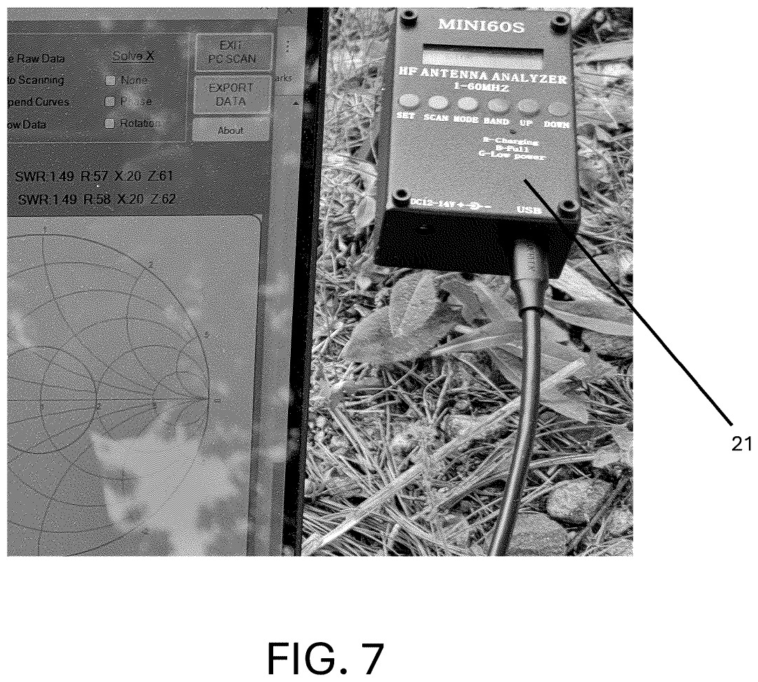

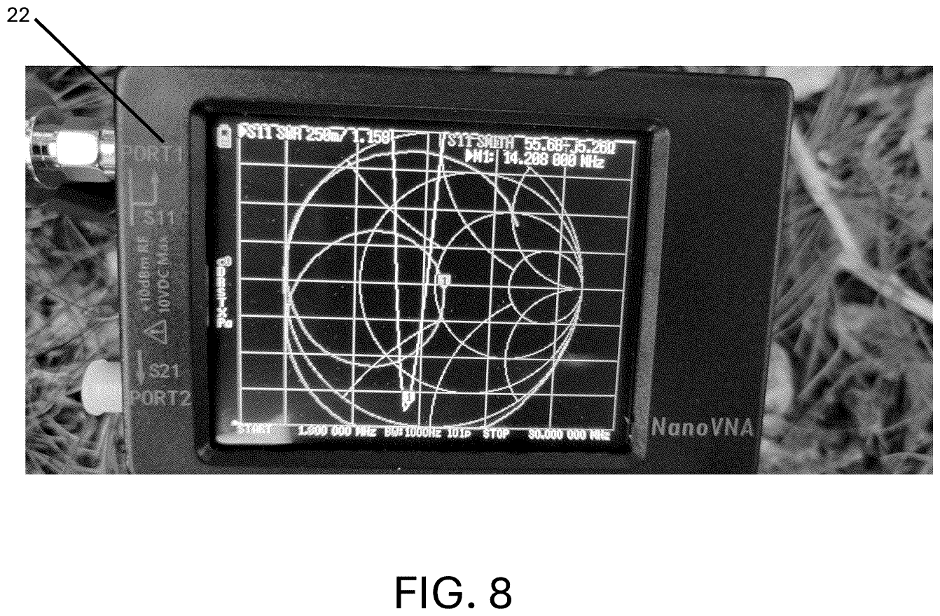

Testing and data collection of one or more embodiments can include inflation and positioning of the antenna, such as depicted via antenna 20 in FIG. 6. As also depicted in FIG. 7, a MINI60S (SARK-100 derivative) antenna analyzer 21 was used during initial tests. Also, additional measurements were made using a NanoVNA vector network analyzer 22 as depicted in FIG. 8, with data display visible.

Testing indicated that at least one example embodiment performs effectively in high frequency (HF) bands, particularly the 20-meter band (14.000 to 14.350 MHz), with a measured low SWR of 1.158 at 14.200 MHz (such as detailed in FIG. 8).

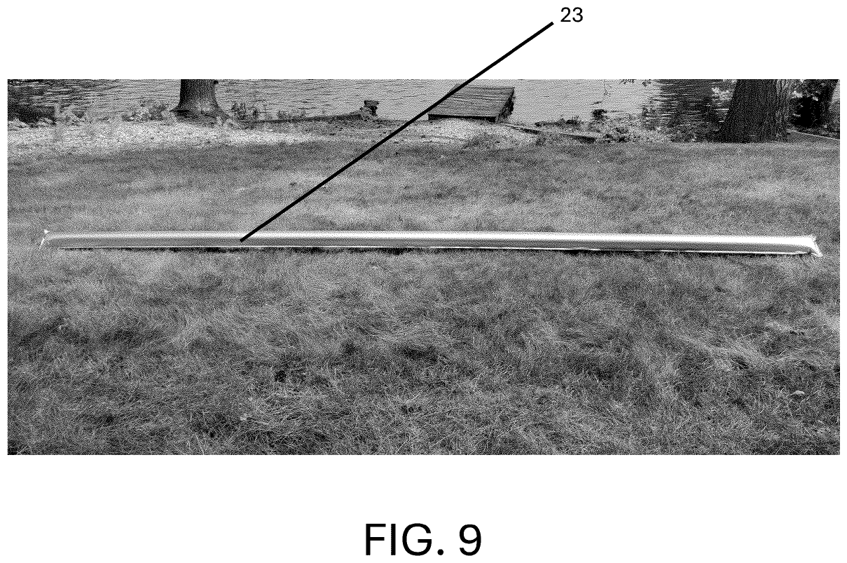

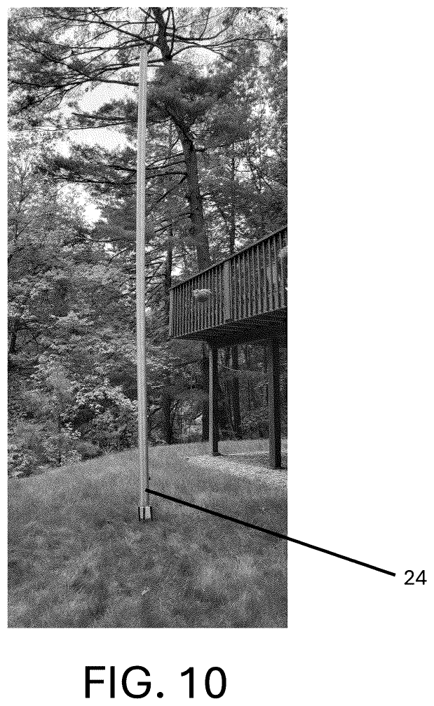

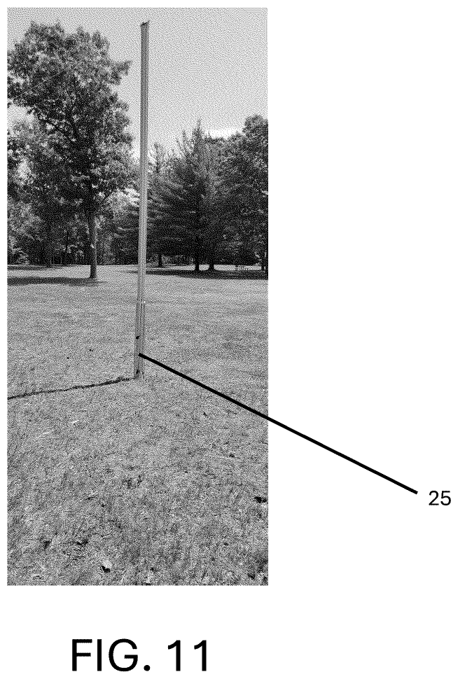

As depicted in FIG. 9, an example antenna 23 is positioned horizontally for ease of work, while FIG. 10 and FIG. 11 depict antenna 24 and antenna 25, respectively, deployed vertically in field settings.

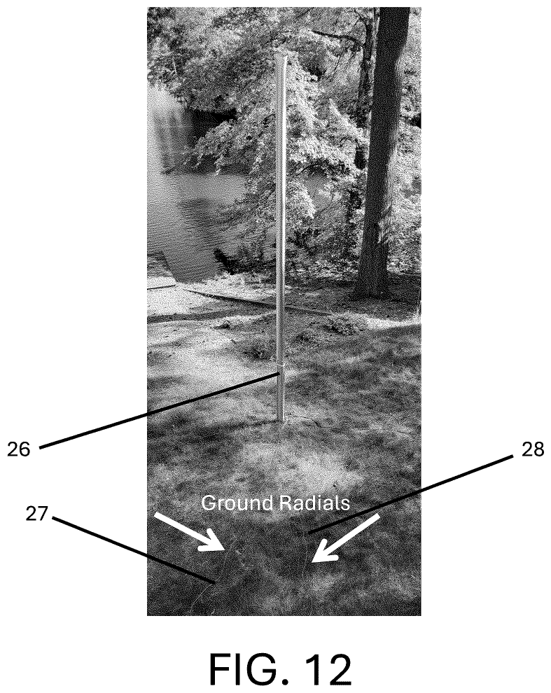

A field photograph of an example embodiment 26 is shown in FIG. 12, with radial wires 27 and 28 visible on the ground.

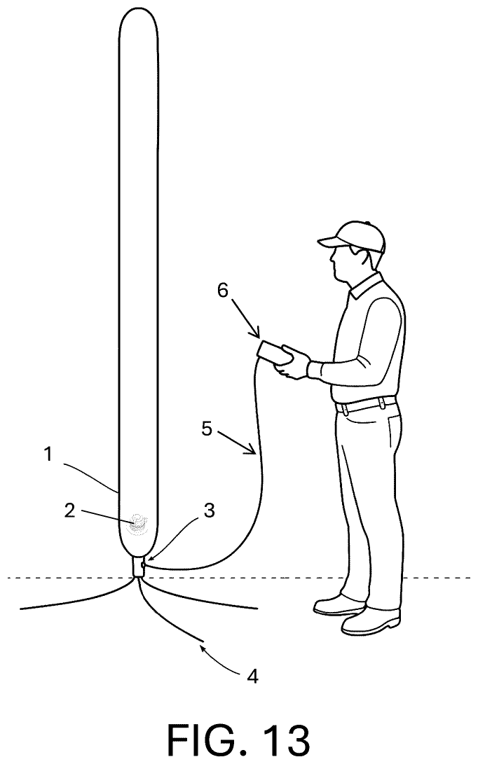

For a supplemental perspective, the technical line drawing of FIG. 13 depicts an example embodiment which includes an inflated pressure-retaining enclosure comprised of a flexible, electrically conductive material 1; an inflation-deflation port 2; an electrical-connectivity port 3; one of three ground radials 4; coaxial cable feedline 5; and an antenna-analyzer device 6.

Although coaxial cable was used as the RF feedline in this example embodiment, it should be noted that there are no limitations to the types of feedlines that can be applied to this and other envisioned and constructed embodiments. In addition to coaxial cable, the following are examples of the many types of feedlines that can be considered: twin lead, ribbon line, window line, ladder line, and other variations of parallel-conductor line. A single-wire RF feedline can also be used. In some antenna designs, such as the vertical/monopole antenna of the example embodiments shown in FIG. 12 and FIG. 13, only a single wire is connected to the antenna element—the inner conductor of the coaxial cable. In these cases, and as described above, it is common that a second wire in the feedline—such as the outer braid of coaxial cable or the non-antenna-connected wire in parallel-conductor feedline—is connected to a counterpoise of some type, including elevated radial elements, an Earth ground, radial wires on the ground or into the soil, a ground screen, and other counterpoise options. In this example embodiment, the outer braid of the coaxial cable (the second wire of the feedline) is connected to the radial wires on the ground, as previously referenced and shown via elements 27 and 28 in FIG. 12, and via element 4 in FIG. 13.

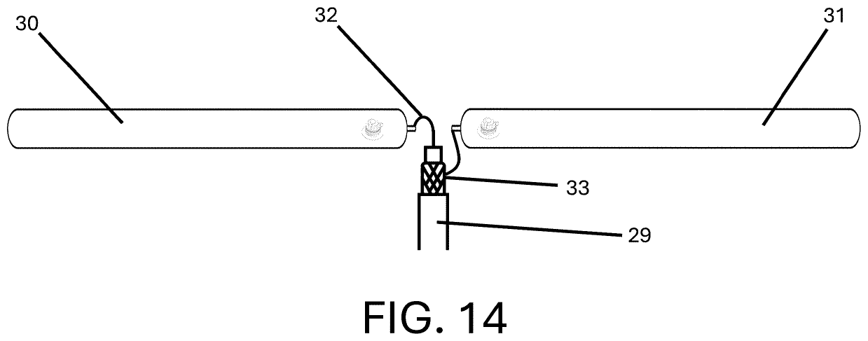

In other antenna designs, such as a dipole antenna depicted in FIG. 14, both wires of a typical feedline 29 are directly applied to the two antenna radiators. In this example embodiment, two metalized inflatable structures, 30 and 31, are employed with the inner conductor of the coaxial cable 32 connected to one element of an example embodiment's metalized inflatable structure, and the braid of the coaxial cable 33 is connected to a second element of the metalized inflatable structure. As is to be appreciated by one skilled in the art, coaxial cable is just one example choice of many choices of feedline, including parallel-conductor feedline, that may be applied in this and other antenna configurations.

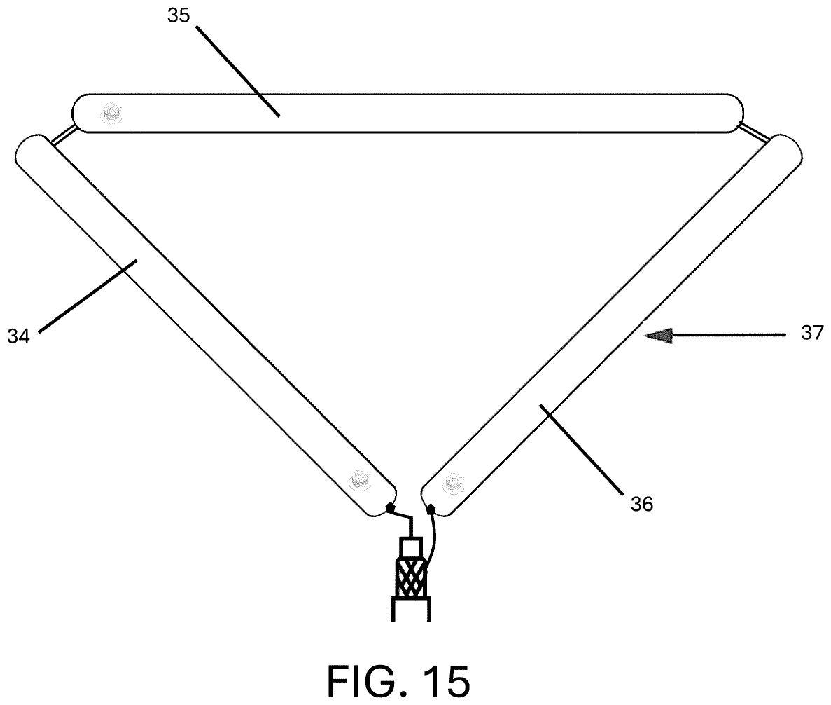

As depicted in FIG. 15, multiple metalized inflatable structures 34, 35, and 36 can be combined in at least one embodiment to create more complex antennas with compound antenna geometries, such as a delta loop antenna 37. Overall, the building-block and/or modular capability of one or more embodiments enable the combination of multiple metalized inflatable structures and facilitate a wide range of antenna designs (with higher performance, less weight, smaller size, and other benefits and virtues described herein). The building-block capability also allows intentional and creative ways to birth novel and, in many cases, unique self-supporting structures—opening new opportunities for enhanced antenna designs.

Also, by way of example, the attachment of the feedline to the antenna detailed in one or more embodiments can be permanent or temporary; wherein a temporary connection can be any of many suitable connectors, such as metal nuts and bolts, clip leads, alligator clips, a banana jack/plug combination (such as shown via element 19 in FIG. 5), PL-259 (male)/SO-239 (female) connector combination, and many other connectors and combinations, including BNC, TNC, SMA, 3.5 mm, 2.4 mm, 2.92 mm/K type, N Type, C Type, 7-16 DIN, EIA Series, FME, SMB, MC, MCX, MMCX, RP-MMCX, UHF, Mini-UHF, U.FL, and Anderson Powerpoles.

One or more embodiments provide numerous benefits over existing antenna designs, as well as novel, unanticipated, and unobvious advantages—including the examples described below.

### Dramatic Weight Savings Compared to Traditional Solid-Metal Antennas:

At least one example embodiment, which includes a vertical/monopole antenna for use on the amateur radio “ham radio” 20-meter band, is much lighter than its traditional counterparts. A traditional, commercially available vertical antenna for the 20-meter band can be, for example, 17-feet tall and weigh approximately 8.00 pounds. In dramatic contrast, at least one example embodiment noted above can, when inflated, be approximately 15.54-feet tall and approximately four inches in diameter—but weigh only 1.6 ounces. The result is an astonishing weight savings of 98.75%—without performance degradation (in fact, likely superior performance, as further detailed below). Applying the metalized-film inflatable structure innovation of one or more embodiments, comparable weight savings can be realized in the vast majority antenna types, such as, for example, those itemized in the BACKGROUND section.

### Bandwidth Superior to Bulky, Heavy Antennas:

It is a known property of metal antenna elements that as the diameter of the conductors increase, there is an increase in an antenna's bandwidth—the range of frequencies that an antenna can operate efficiently. The optimum frequency of an antenna is called its resonant frequency. The broader the bandwidth of an antenna, the wider the range of frequencies the antenna will operate near its resonant frequency. It is common that the operational efficiency near the resonant frequency is expressed as SWR, a measure used to quantify the efficiency of power transfer in transmission lines and antennas. In large part due to the aforementioned skin effect of one or more embodiments, the approximate four-inch diameter inflated size of at least one example embodiment provides comparable bandwidth (e.g., similar SWR measured over a range of frequencies) to a vertical antenna constructed of a four-inch diameter metal tube or pipe—but without the bulk and weight of a four-inch diameter metal tube or pipe.

Not only would an example four-inch diameter inflatable metalized-film embodiment be comparable in bandwidth to a four-inch diameter metal tube or pipe, but it would be superior in bandwidth to the vast majority of conventional vertical antennas. Most such conventional vertical antennas of the approximate 17-foot height are comprised of multiple, connected-together sections of metal tube or pipe that have much smaller diameters—1.5 inches or less. Thus the bandwidth of an example four-inch diameter inflatable metalized-film embodiment would be expected to be superior to such conventional offerings.

### Reduced Deployment Size Compared to Traditional Solid-Metal Antennas:

As previously mentioned, an inflatable antenna such as detailed herein in connection with one or more embodiments enables approximately a 4%-9% size reduction compared to antenna designs made of traditional solid metal or wire. For instance, a typical conventional antenna offers the lowest SWR on the 20-meter band at lengths between 16 feet 8.5 inches and 16 feet 3⅝ inches. In contrast, an example embodiment of an inflatable antenna provides the lowest 20-meter band SWR at a length of 15.54 feet.

### Enhanced Bandwidth, Reduced Deployment Size, and Less Weight Compared to Traditional Wire-Based Antennas:

Further regarding antenna conductor size and its relation to bandwidth, wire antennas can suffer from narrower bandwidths than those constructed of metal tubes, pipes, or other substantially rigid elements. For instance, a wire dipole antenna for the 40-meter amateur-radio band is typically 66 feet, end to end (e.g., the wire is traditionally bisected for feedline attachment). A wire commonly used for dipole antennas is #14 AWG stranded, hard-drawn copper; this wire has a diameter of approximately 0.0641 inches. An alternative dipole antenna, as described herein, could be created that would provide substantially greater bandwidth by using a tubular element (of essentially any convenient diameter) of one or more embodiment's metalized-film inflatable structure. An example of such an embodiment is depicted in FIG. 14.

An additional benefit is decreased end-to-end deployment length. Depending on the selected metalized inflatable structure diameter, the resulting dipole antenna (again, as previously referenced and described in FIG. 14) may be approximately 4% to 9% shorter than a wire-based dipole antenna intended for the same frequency range. Applying knowledge gained from the 20-meter metalized inflatable antenna research and testing described herein, the needed end-to-end length for a 40-meter dipole comprised of two four-inch-diameter metalized-film inflatable structures would be 15.54 feet×2 (e.g., a typical 40-meter antenna is twice the length)×2 (two sections needed to create a dipole)=62.16 feet. The result is an antenna with a 5.82% decreased deployment length.

A further benefit is decreased weight. 66 feet of #14 AWG stranded, hard-drawn copper wire weighs approximately 13.2 ounces. In contrast, a 40-meter dipole that is 62.16 feet long constructed with two four-inch-diameter inflatable structures made with metallized film would have an approximate weight of just 6.4 ounces—more than 50% weight savings.

### Weight Savings, Bandwidth Improvements, and Additional Benefits in Other Antenna Types:

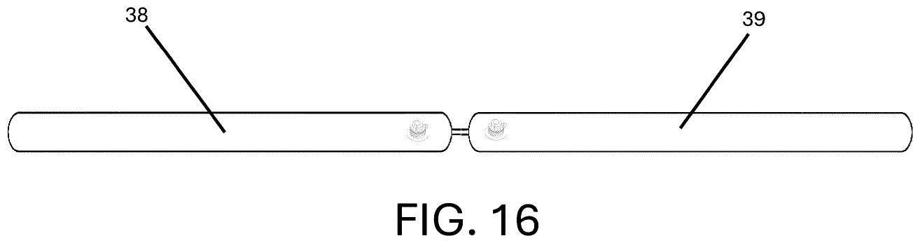

For instance, a popular antenna type is a directional antenna called a Yagi-Uda antenna (commonly referred to as a Yagi antenna or Yagi beam or Yagi beam antenna). Yagi antennas are typically comprised of multiple, parallel, rigid-metal radiating elements (typically aluminum tubes or rods or stainless-steel tubes or rods) affixed to a boom. Alternatively, one or more embodiments can include creating a Yagi beam comprised of metalized-film inflatable radiating elements affixed to a boom. The driven element could be comprised of a structure similar to the metalized-film inflatable dipole example previously referenced and described FIG. 14. And the parasitic elements could be comprised of connected pairs of the metalized-film inflated structures, such as depicted by the connected pairs, 38 and 39, in FIG. 16. Such an embodiment would perform comparability—in fact, likely superior to—a conventional Yagi beam comprised of solid-metal radiating elements, but with a substantial decrease in bulk and weight.

For instance, an example conventional Yagi antenna weighs 9.9 pounds, and has three half-inch diameter aluminum-tube radiating elements. Using the metalized-film inflatable tube structures as radiators (as described above) to create a three-element 10-meter Yagi antenna, the resulting antenna of one or more embodiments would weigh a tiny fraction of the above-noted conventional Yagi antenna—all while providing comparable-to-superior bandwidth; the superior bandwidth would be achieved by using the metalized-film inflatable radiator elements that have any diameter greater than the half-inch diameter aluminum-tube elements of the conventional Yagi antenna. An additional benefit would be a decreased antenna turning radius, as the inflatable-film metalized radiators would be 4%-9% shorter, for the reasons previously described.

### Extreme Portability:

Solid-metal antenna structures, even when disassembled into multiple sections and/or components, can still be multiple feet long. Even vertical/monopole antennas that may use a telescoping design for deployment are still typically multiple feet long when fully reduced in length. In marked contrast, at least one example embodiment, when deflated, can be rolled up and/or folded and fit inside a pocket of a person's clothing. The portability of a wide range of antenna types and designs—such as many that were itemized in the BACKGROUND section—can be greatly enhanced using the metalized-film inflatable structures and techniques detailed herein in accordance with one or more embodiments.

### Enhanced Visibility Over Traditional Antenna Types:

The example metalized-film inflatable antenna embodiment (and other embodiments that can be readily conceived, including metalized-film inflatable construction alternatives to traditional antenna types as previously itemized in the BACKGROUND section) would be naturally reflective when reflective versions of metalized film are chosen for construction. This enhanced visibility can assist in an emergency situation, such as finding a lost hiker by aircraft. Of course, in one or more embodiments, inflatable antenna structures could be made non-reflective with the choice of non-reflective metalized film and/or with the addition of various coatings, dyes, etc. For instance, for stealthy deployment, the inflatable structure's surface could be made black or other dark color.

### Lower Cost to Manufacture Over Traditional Antenna Types:

Traditional antennas typically require substantial metal hardware, extensive machining, and can be a labor-intensive process. In contrast, the inflatable antenna structure of one or more embodiments requires minimal materials, and lends itself to simplified manual production and/or streamlined automated production.

### Lower Transportation and Shipping Costs Over Traditional Antenna Types:

Due to miniscule weight and uninflated size, antennas based on the inflatable structure of one or more embodiments can be affordable to transport and ship—providing cost-saving and logistical advantages throughout the manufacturing and distribution supply chains.

### Lighter-than-Air Applications—and Associated Performance Benefits:

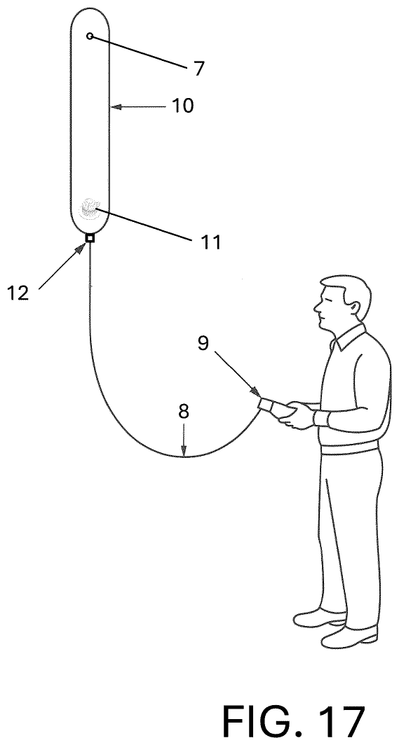

An inflatable design supports helium inflation for self-lofting operation. By way of illustration, an example embodiment is illustrated in FIG. 17, which depicts a helium-inflated pressure-retaining enclosure comprised of a flexible, electrically conductive material 10. In this example embodiment, an overpressure valve 7 may be integrated for high-altitude gas-pressure compensation, and a lightweight feedline tethering 8 with RF-capable wire (e.g., RG178 and RG316 coaxial cable and 28-32 AWG magnet wire) is also implemented. Also shown is an inflation-deflation port 11; an electrical-connectivity port 12; and a compact transceiver 9.

It should be noted that the lightweight feedline depicted in FIG. 17 can be any length (e.g., from a few feet to many hundreds of feet—or more). Generally, the higher any antenna is mounted, the greater the enabled communication range. Particularly in field, portable, and emergency operations, it is quite impractical to erect an antenna-support tower that is hundreds of feet tall. The unique ability of one or more embodiments to be able to be lofted and deployed hundreds or more feet into the sky provides, in many cases, previously unachievable communication performance.

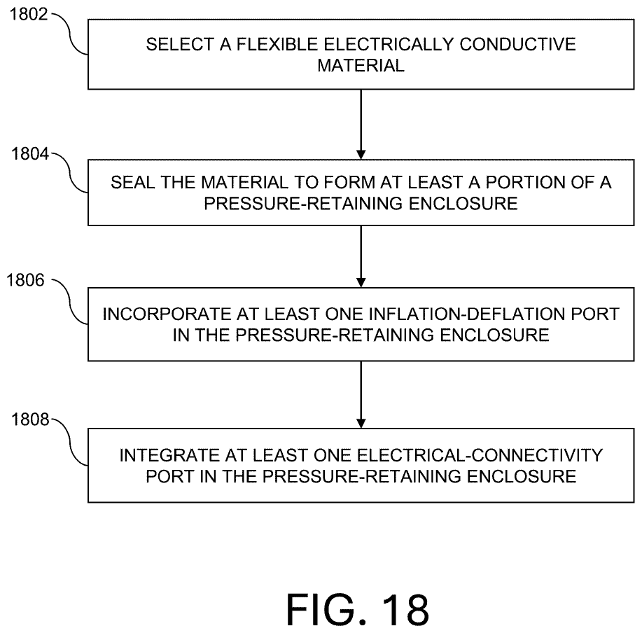

FIG. 18 is a flow diagram of a method for manufacturing an inflatable radio-frequency antenna structure. Step 1802 includes selecting a flexible, electrically conductive material. Step 1804 includes sealing the material to form at least a portion of a pressure-retaining enclosure. Step 1806 includes incorporating at least one inflation-deflation port in the pressure-retaining enclosure. Also, step 1808 includes integrating at least one electrical-connectivity port in the pressure-retaining enclosure. In one embodiment, a monopole antenna, among other designs, may be created. In a further embodiment, multiple structures may be combined and/or manufactured to create complex antenna structures with compound antenna geometries, such as dipole antennas, loop antennas, delta-loop antennas, cloverleaf antennas, helical antennas, parabolic antennas, driven array antennas, phased array antennas, and parasitic array antennas, among others. Additionally, in at least one embodiment, electrical continuity between structures and/or other antenna elements and/or connectors may be employed.

1. An inflatable radio-frequency antenna structure comprising:
a flexible, electrically conductive material,
a pressure-retaining enclosure formed from said material,
at least one inflation-deflation port in said pressure-retaining enclosure, and
at least one electrical-connectivity port in said pressure-retaining enclosure.

2. The inflatable radio-frequency antenna structure of claim 1, wherein said flexible, electrically conductive material comprises a metalized plastic film.

3. The inflatable radio-frequency antenna structure of claim 2, wherein said metalized plastic film is selected from a group comprising: chrome-metallized plastic film, aluminum metalized plastic film, gold-metallized polyester plastic film, brushed stainless steel plastic film, metal pewter plastic film, matte-aluminum plastic film, and metalized biaxially oriented polyethylene terephthalate plastic film.

4. The inflatable antenna structure of claim 1, wherein said pressure-retaining enclosure is configured to form a radio-frequency reception and radiating structure.

5. The inflatable radio-frequency antenna structure of claim 1, wherein said inflatable radio-frequency antenna structure is configured as a monopole antenna.

6. The inflatable radio-frequency antenna structure of claim 1, wherein a plurality of instances of said radio-frequency inflatable antenna structure are interconnected to implement one or more compound antenna geometries comprising at least one of: a dipole configuration, a loop configuration, a delta-loop configuration, a cloverleaf configuration, a helical configuration, a parabolic configuration, a driven array configuration, a phased array configuration, and a parasitic array configuration.

7. The inflatable radio-frequency antenna structure of claim 1, wherein said at least one inflation-deflation port comprises a resealable component selected from a group comprising: a plug, a cap, a plastic valve, a metal valve, and a metal-plastic hybrid valve.

8. The inflatable radio-frequency antenna structure of claim 1, wherein said at least one electrical-connectivity port comprises a radio-frequency-capable connector configured to accommodate a feedline selected from a group comprising: a coaxial cable, a parallel-conductor line, and a single-wire conductor.

9. The inflatable radio-frequency antenna structure of claim 1, further comprising at least one overpressure valve positioned as part of said pressure-retaining enclosure.

10. The inflatable radio-frequency antenna structure of claim 1, wherein said structure is filled with at least one lighter-than-air gas.

11. A method for manufacturing an inflatable radio-frequency antenna structure, comprising:
selecting a flexible electrically conductive material,
sealing said material to form at least a portion of a pressure-retaining enclosure, incorporating at least one inflation-deflation port in said pressure-retaining enclosure, and integrating at least one electrical-connectivity port in said pressure-retaining enclosure.

12. The method of claim 11, configuring said inflatable radio-frequency antenna structure as a monopole antenna.

13. The method of claim 11, further comprising configuring a plurality of instances of said radio-frequency inflatable antenna structure for interconnection to implement at least one compound antenna geometry.

14. The method of claim 13, wherein said at least one compound antenna geometry is selected from a group comprising a dipole configuration, a loop configuration, a delta-loop configuration, a cloverleaf configuration, a helical configuration, a parabolic configuration, a driven array configuration, a phased array configuration, and a parasitic array configuration.

15. The method of claim 13, further comprising establishing electrical continuity between two or more instances of the inflatable radio-frequency antenna structure using one or more connectors selected from a group comprising one or more mechanical connectors, one or more soldered connectors, and one or more adhesive connectors.

16. The method of claim 13, further comprising interconnecting two or more instances of the inflatable radio-frequency antenna structure using one or more elements selected from a group comprising shared one or more inflation channels, one or more structural couplings, and one or more RF signal junctions.

17. The method of claim 11, wherein said sealing said material to form at least a portion of a pressure-retaining enclosure comprises using one or more techniques selected from a group comprising heat sealing, adhesive bonding, ultrasonic welding, mechanical fastening, and one or more other sealing methods.

18. The method of claim 17, wherein said sealing is implemented using at least one device comprising at least one of an impulse heat sealer, a handheld adhesive applicator, and a battery-operated ultrasonic tool.

19. The method of claim 11, further comprising incorporating at least one overpressure valve in said pressure-retaining enclosure.
